(19) United States
(12) Patent Application Publication
(10) Pub. No.: US 2008/0202000 A1
(43) Pub. Date: Aug. 28, 2008

(54) Automotive info-cator

(76) Inventor: Raymond Michael Wilder, New Windsor, MD (US)

Correspondence Address: Raymond M. Wilder, 2607 Sam's Creek Road, New Windsor, MD, 21776, US

(21) Appl. No.: 12/012,602

(22) Filed: Mar. 26, 2008

Related U.S. Application Data
(60) Provisional application No. 60/902,631, filed on Feb. 22, 2007.

(51) Int. Cl. G09F 1/12

(52) U.S. Cl. 40/124

(57) ABSTRACT

The Automotive Info-cator is designed to assist and organize the Automotive Repair Industry, by placing all repair and insurance related information in one highly visible, accessible, water-resistant place. This information is then available for the repair technician, parts staff, and insurance estimators. The Info-cator acts as a line of communication between the office staff and all others involved in the repair process.

1. The Automotive Info-cator is designed to assist and organize the Automotive Repair Industry, by placing all repair and insurance related information in one highly visible, accessible, water-resistant place. This information is then available for the repair technician, parts staff, and insurance estimators. The Info-cator acts as a line of communication between the office staff and all others involved in the repair process.

The product is held in place between a moveable window and glass run in any automotive door. It stands up vertically 18 inches, like a flag that is visible above the vehicle roof. It is made of plastic and designed to be weather resistant. On either side of an 18-inch high by 1-inch wide vertical mast are two flag-like areas. The side panels will be see-through so that the information is visible. On the other side of the vertical mast is another flag-like area to allow for placement of color-coded or numbered cards to identify specific companies or repair technicians. On the mast is a key slot to place the key to the vehicle that is being repaired. At the bottom of the vertical mast is a part that is placed between the movable glass and the glass run and held tight when the moveable glass is closed.

My invention of the Automotive Info-cator is designed to assist and organize the Automotive Repair Industry. This product is held in place between a moveable window and glass run for any automotive door. It is made of plastic or non-corrosive metal. It is weather resistant with a see through panel approximately 12 inch high and 14 inches long. Almost flag like and large enough to contain a standard file that will hold the information concerning a particular vehicle. The other side of the flag mast will have a 4 inch by 12 inch see through panel. Inside the panel are color coded cards that designate specific company information. There is also a key slot on the mast to place the key to the vehicle being repaired.

### DESCRIPTION

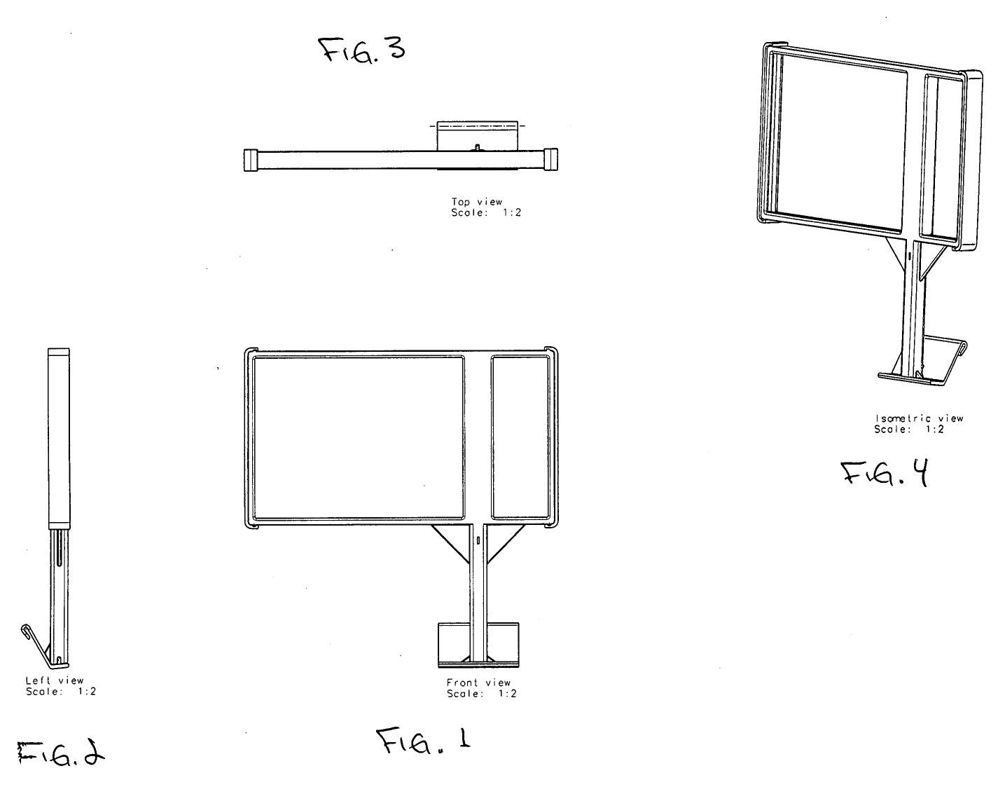

FIG. 1 is a front perspective view thereof;

FIG. 2 is a side perspective view thereof;

FIG. 3 is a top plan view thereof;

FIG. 4 is a 3 dimensional view thereof;

1. The Automotive Info-cator is designed to assist and organize the Automotive Repair Industry, by placing all repair and insurance related information in one highly visible, accessible, water-resistant place. This information is then available for the repair technician, parts staff, and insurance estimators. The Info-cator acts as a line of communication between the office staff and all others involved in the repair process.
(1a). The product is held in place between a moveable window and glass run in any automotive door. (2a) It stands up vertically approximately 18 inches, like a flag that is visible above the vehicle roof. It is made of plastic and designed to be weather resistant. (2a) On either side of an 18-inch high by 1-inch wide vertical mast are two flag-like areas. (3a) The side panels will be see-through so that the information is visible. (3a) On the other side of the vertical mast is another flag-like area to allow for placement of color-coded or numbered cards to identify specific companies or repair technicians. (4a) On the mast is a key slot to place the key to the vehicle that is being repaired. (1a) At the bottom of the vertical mast is a part that is placed between the movable glass and the glass run and held tight when the moveable glass is closed.
